(19) United States
(12) Patent Application Publication
(10) Pub. No.: US 2022/0051359 A1
(43) Pub. Date: Feb. 17, 2022

(54) EDUCATION MANAGEMENT METHOD AND SYSTEM

(71) Applicant: Mariana Godinez, Miami, FL (US)

(72) Inventor: Mariana Godinez, Miami, FL (US)

(21) Appl. No.: 16/992,207

(22) Filed: Aug. 13, 2020

(51) Int. Cl. G06Q 50/20; G06Q 30/06

(52) U.S. Cl. CPC G06Q 50/205; G06Q 30/0645

(57) ABSTRACT

The method for education management comprises creating a business entity for providing educational services, which may include childcare and/or preschool through eighth grade instruction, to children of employees of a company, occupying, by the business entity, a commercial space that is owned or leased by the company, providing, by the business entity, educational services to the children of the employees within the commercial space, and charging, by the business entity, the company or parents of the children for said educational services, wherein said charges are reduced proportional to savings realized by the business entity due to use of the commercial space that is owned or leased by the company.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The claimed embodiments relate to education management, and more specifically, to the field of systems and methods for management of child education.

### BACKGROUND

The concept of providing daycare services and/or child education services within a close distance of one's employment is one that includes multiple benefits for the employees, employers, and the overall working environment. For example, banks and investment groups that provide on-site childcare programs for employees have experienced a return of investment of over 100% due to the inherent benefits of providing these services for their employees. These inherent benefits for the employees include increased loyalty of employees to their employer, improved employee morale, additional bonding time with children, and many other benefits. For example, on-site childcare and/or child education services allow employees to spend more time with their children during the work week, improve concentration on the job, and reduce anxieties associated with parental duties. Certain issues that were historically associated with returning to work after maternity and/or paternity leave have been eliminated or reduced due to the integration of on-site childcare and/or child education services. For example, many parents to newborns worry about returning from maternity and/or paternity leave too soon and missing out on intimate moments with their infant such as breastfeeding, bonding time, the child's first steps, etc. All of the aforementioned are circumvented by having one's child in a safe and secure environment within a close proximity to the parent's work environment.

In addition, employers reap benefits aside from a high return of investment by integrating on-site childcare and/or child education services. For example, on-site services are directly correlated to lower absenteeism, lower turnover, and reduction of common costs such as hiring and training replacements for new parents. Furthermore, availability of on-site childcare and/or child education services exposes companies to a wider variety of applicants due to the targeting of individuals with a family-first approach to their work/life balance.

However, due to the regulatory requirements, logistics, expenses, and other obstacles associated with integrating on-site childcare programs, many employers are hesitant to integrate these services. For example, employers are hindered by increased insurance premiums, increased exposure to liability, and other issues associated with providing on-site childcare services.

Therefore, there exists a need for improvements to providing an education management method and system for employees covered by the employer that capitalizes on incentives provided with on-site childcare and/or child education services.

### SUMMARY

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for education management is disclosed. The method for education management comprises creating a business entity for providing educational services, which may include childcare and/or preschool through eighth grade instruction, to children of employees of a company, occupying, by the business entity, a commercial space that is owned or leased by the company, providing, by the business entity, educational services to the children of the employees within the commercial space, and charging, by the business entity, the company or parents of the children for said educational services, wherein said charges are reduced proportional to savings realized by the business entity due to use of the commercial space that is owned or leased by the company.

To the accomplishment of the above and related objects, the claimed embodiments may take the form illustrated in the accompanying drawings, attention being called to the fact, however, that the drawings are illustrative only, and that changes may be made in the specific construction illustrated and described within the scope of the appended claims. The foregoing and other features and advantages of the claimed embodiments will be apparent from the following more particular description of the preferred embodiments, as illustrated in the accompanying drawings.

### BRIEF DESCRIPTION OF THE DRAWINGS

The accompanying drawings, which are incorporated in and constitute part of this specification, illustrate the claimed embodiments and together with the description, serve to explain the principles of the claimed embodiments. The embodiments illustrated herein are presently preferred, it being understood, however, that the invention is not limited to the precise arrangements and instrumentalities shown, wherein:

FIG. 1 is a flowchart of the overall processing overflow performed by an illustrative embodiment of the method for education management;

FIG. 2 is an exemplary block diagram illustrating a set of equations associated with a system and method for education management;

FIG. 3 is an exemplary block diagram illustrating an overall environment for the system and method for education management.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system and method for education management configured to create a business entity that provides educational services to children of employees of a company on-site or substantially near the workplace associated with the company. The system and method provide a plurality of benefits to the employees by facilitating safe and reliable educational services to the children of employees resulting in an increased amount of time and bonding between parents and their children caused by the shared commute and enhanced interactions, a reduction in parental-related anxieties caused by traditional childcare concerns and associated costs, and an increased amount of employee loyalty to the company based upon on the company being cognizant of their employees' familial concerns relating to the supervision and education of the employees' children. In addition, the system and method provide a plurality of benefits to the employer such as tax benefits, increased employee productivity, and a lower turnover rate in exchange for the employer furnishing the business entity with the operating space for administering educational services.

The method for educational management includes the provision of educational services from a business entity to a company. A company is a legal entity representing an association of people with a specific business objective, such as a bank that provides banking services to the public or a public utility that provides utility services to the public. Company members, i.e., employees, share a common purpose and unite to achieve specific, declared goals. Companies include voluntary associations, which may include nonprofit organizations, business entities, whose aim is generating profit, financial entities, banks, programs and educational organizations. A business entity is an entity that is formed and administered as per corporate law, and may take many forms such as corporations, cooperatives, partnerships, sole traders, limited liability companies and other specifically permitted and labelled types of entities.

It is to be understood that the business entity referred to throughout the disclosure is a third-party entity separate from the company (hereinafter referred to as “employer”) and the employer's employees. That is, the business entity is an entity separate and distinct from the company. In one embodiment, the business entity is an education management business entity configured to provide educational services to the children of the employees at a location associated with the employer, such as a commercial space or any other area configured to be rented for commercial purposes for taking care of and/or educating children during normal working hours. In one embodiment, the business entity is configured to provide educational services during extended hours outside of normal business hours (extended care or weekend care).

Childcare, otherwise known as day care, is the care and supervision of a child or multiple children at a time, whose ages range from six weeks to thirteen years. Childcare is the action or skill of looking after children by a day-care center, nannies, babysitter, teachers or other providers. Childcare is a broad topic that covers a wide spectrum of professionals, institutions, contexts, activities, and social and cultural conventions.

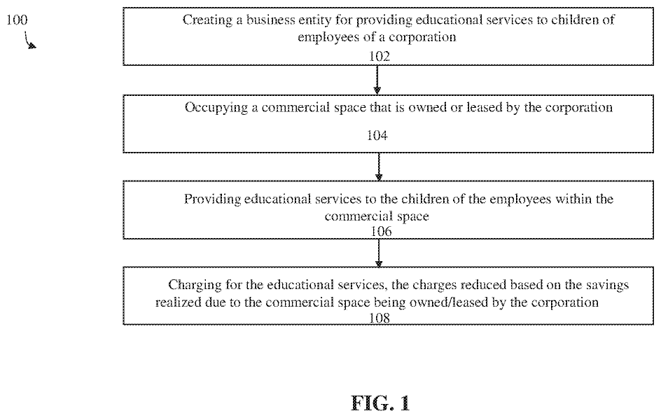

Referring now to FIG. 1, a method for educational management 100 begins at step 102, wherein a business entity is created for providing educational services to children of employees of a corporation, such as childcare and preschool through eighth grade classroom instruction. In one embodiment, the educational services may be provided via a virtual learning experience configured to host interactive teaching sessions for the children of the employees. In one embodiment, the virtual learning experience may be used as simply an education assistance mechanism in the location configured to keep the children of the employees engaged within the location. A virtual learning experience comprises instruction and educational services that are provided to a child via video conference, the use of video lessons, and the like.

In one embodiment, the educational services comprises services provided to one or more of the following classes of students: preschool (0-5 years old), prekindergarten (4-5 years old), kindergarten (5-6 years old), primary school (6-11 years old, or first through fifth grade), and secondary school (11-14 years old, or sixth through eighth grade).

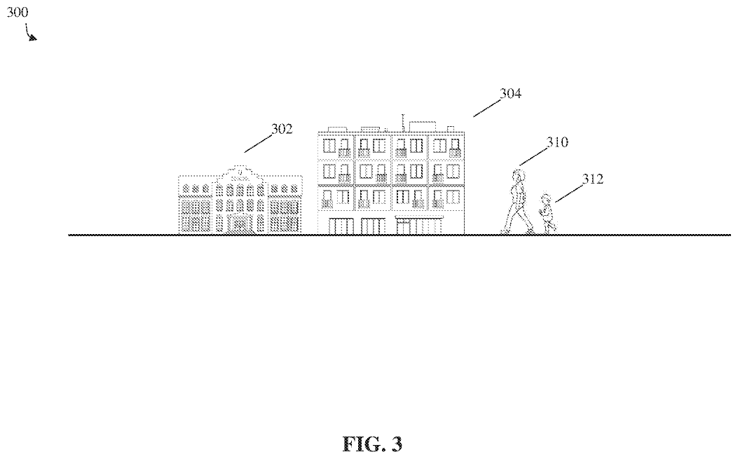

At step 104, the business entity occupies a commercial space (hereinafter referred to as “the location”) configured to be owned, rented or leased by the employer. As shown in FIG. 3, the location 302 may be in the same commercial space 304 used by the company to house its employees or may be substantially proximate to the commercial space 304 used by the company to house its employees. In said embodiment, an employee 310 of the company can quickly and easily transport his or her child 312 to and from the location 302 before, during or after the employee engages in work at the commercial space 304 used by the company.

In one embodiment, the location is a learning environment configured to comprise a plurality of academic components, a plurality of extra-curricular components, and a plurality of nutritional substance components in which the learning environment is suitable for children of all ages. Examples of the plurality of academic components include but are not limited to valid certifications of all educational professionals operating in the location, a diversity of intelligence curriculum configured to be distributed to the children, an emotional awareness curriculum, a parental schooling program, a juvenile hygiene program, a caregiving station for non-emergency pediatric needs, and any other applicable mechanisms associated with educational management. Examples of the plurality of extra curricular activities include but are not limited to yoga, music, dance, art, science, physical education, and any other applicable non-academic activities. Examples of the plurality of nutritional substance components include but are not limited to at least one homemade meal a day, and at least two healthy snacks distributed to the children throughout the day. Additional non-educational services provided at the location may include sports programs, hobby instruction and open area for rest and relaxation.

In one embodiment, the commercial space may be owned, rented, and/or leased by the business entity or the commercial space may be associated with the business entity in which the business entity owns, rents, and/or leases the location itself. However, in this embodiment, the employer would be responsible for the mortgage, rent or lease payments. The employer may elect for on-site educational management in which the employer is responsible for the mortgage, rent or lease payments for the commercial that the business entity is operating within.

At step 106, the business entity provides the aforementioned educational and non-educational services to the children of the employees within the location. It is to be understood that while the children are in the custody of the business entity, the business entity assumes liability of the children until the children are returned to the custody of their parents (the employees). The benefit of the on-site location (the educational services being provided within the same location as the employer's workspace, or a proximate location) is to ensure a seamless commute for an employee in which they may drop off their children at the location prior to or during the beginning of their workday and pick up their children at the end of the workday. In one embodiment, the employee may sign their children out of the location in order to take the one or more children to lunch and sign the child back in so that both the parent and children may finish the remainder of their day. In one embodiment, the system for educational management further comprises an attendance tracking mechanism configured to automatically account for the attendance of the children in addition to tracking of the signing in and signing out of each individual child within the care of the business entity.

At step 108, the business entity charges the employer and or the parents of the children (i.e., the employees) for the aforementioned educational and non-educational services, wherein said charges are reduced proportional to savings realized by the business entity due to use of the commercial space that is owned or leased by the company, as described more fully below.

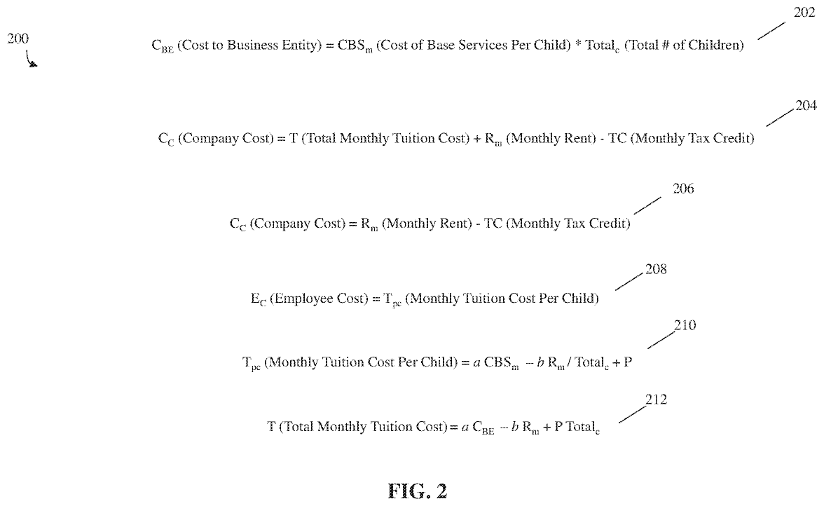

Referring now to FIG. 2, a set of formulae 200 associated with the method of educational management 100 is depicted according to an example embodiment. The set of formulae 200 comprises a first formula 202 representing an exemplary total monthly cost of educational and non-educational services provided by the business entity. The total cost of educational services provided by the business entity is subject to adjustment based on a plurality of factors. For example, first formula 202 may reflect a scenario in which the business entity provides a plurality of investments into the location in exchange for the employer providing or paying the location (mortgage payments, rent payments, lease payments, for example). Examples of the aforementioned investments include but are not limited to construction/decorum/architectural layout of the location, city permits/licenses and other applicable certification documentation, furniture, fixtures, childproofing, and any other applicable fees and/or tasks associated with the upkeep of the location.

In application of first formula 202, C_{BE} represents total monthly cost to the business entity of providing educational and non-educational services for all children of employees of the company, CBSₘ represents the monthly cost of base services per child associated with the business entity providing educational and non-educational services, and Total_{c} is a total number of children of employees of the company that are being provided educational services. In this example the monthly cost of base services per child is adjusted based on a minimum of 200 children enrolled at a monthly cost of base services per child of $950. Thus, the total monthly cost of educational and non-educational services incurred by the employer is equal to 200×$950=$190,000.

CBSₘ, the monthly cost of base services per child associated with the business entity providing educational and non-educational services, may be calculated in a variety of ways. In one embodiment, the value is calculated by calculating all expenses and costs of the business entity for one month (including electricity, water, sewer, supplies, labor expenses, employment expenses, cost of goods purchased, cost of business licenses, costs of inspections, etc.) and dividing said value by Total_{c}, the total number of children of employees of the company that are being provided educational services. In an alternative embodiment, the first formula 202 may be revised to include a fixed monthly cost value (such as a variable Fₘ) that represents fixed monthly costs that do not vary by number of children being provided services, such as the cost of a business license, the cost of electricity, the labor cost of a principal, etc.). In this alternative embodiment, the variable Fₘ is added to CBSₘ and the value of CBSₘ is limited to those costs that only vary per number of children being provided services, such as water, supplies, labor expenses, employment expenses, cost of goods purchased, etc.

In application of second formula 204, the company is configured to pay for the location and for the tuition for all of the children of employees. C_{C} (company cost) represents the total monthly cost incurred by the employer accounting for tax incentives and T is a total monthly tuition charge for the educational and non-educational services provided to all children. Rₘ is the monthly rent (or mortgage payment or lease payment or fair market value for the rent or lease payment) for the commercial space. TC is the monthly tax credit provided to the employer by governmental authorities for its childcare and/or educational expenses. In one embodiment, the employer receives a tax credit equal to 25% of childcare facility expenditures in addition to 10% of the qualified childcare resource and referral expenditures paid or incurred during the tax year. Thus, the tax credit provided to the employer if the employer provides or pays for the location (rent/mortgage/lease) could be close to or equal to Rₘ, the monthly rent, leaving only T (total monthly tuition charge) to be paid by the employer. In one embodiment, the employer can further deduct a calculated percentage of unrecovered costs from the applicable corporate taxes.

Note that as shown with regard to formula 204, the aforementioned system and method for educational management in the preferred embodiment not only ensures that the employer receives a year tax credit, but also a reduction in tuition, as shown below with regard to the formula for calculating tuition charges. It is important to consider that the amount that is saved is attributed to multiple factors; in particular; the aforementioned preferred embodiment is supplemented by a significant amount of investment by the business entity into the location of the commercial space and a lack of assumption of the lease, rent or mortgage payments for the location.

In application of third formula 206, the company is configured to pay for the location but not for the tuition for the children of employees. Cc (company cost) represents the total monthly cost incurred by the employer accounting for tax incentives. Rₘ is the monthly rent (or mortgage payment or lease payment or fair market value for the rent or lease payment) for the commercial space. TC is the monthly tax credit provided to the employer by governmental authorities for its childcare and/or educational expenses. In one embodiment, the employer receives a tax credit equal to 25% of childcare facility expenditures in addition to 10% of the qualified childcare resource and referral expenditures paid or incurred during the tax year. In one embodiment, the employer can further deduct a calculated percentage of unrecovered costs from the applicable corporate taxes.

Fourth formula 208 assumes that the employer is not covering cost of the educational services provided by the business entity assumes. In this example, the monthly employee cost (E_{C}) is equal to the monthly tuition cost of educational services rendered by the business entity.

In a preferred embodiment, the system and method of educational management is designed and configured to deduct less than or equal to 35% of unrecovered costs from a corporate tax associated with the employer. It is to be understood that the system and method of educational management is configured to be established in a manner that does not require any investment on behalf of the employer besides the location or commercial space. The ultimate goal of the system and method is to provide a secure foundation for child education via an on-site location within a professional's workplace in order to simultaneously provide the on-site education management for the professional's offspring in addition to increase productivity and work-life balance within the professional's workspace.

Fifth formula 210 shows how the business entity charges the company or the employee (parent or the child being educated) a monthly tuition charge per child for the educational services it provides, wherein T_{pc} is a total monthly tuition charge per child for the educational services:

T_{pc}=aCBSₘ−bRₘ/Total_{c}+P

wherein T_{pc} is a total monthly tuition charge per child for the educational services, CBSm is a total monthly cost of base educational services per child, Rₘ is fair market value for monthly rent for the commercial space, P is a monthly profit amount per child, Total_{c} is a total number of children being provided educational services, a is a coefficient real number with a range of 0≤a≤1 and b is a coefficient real number with a range of 0≤b≤1.

The coefficient a may be adjusted to vary the degree to which the total monthly cost of base educational services per child (CBSₘ) is being charged to the employer or employee. Put another way, the coefficient a may be adjusted to vary the degree to which the total monthly cost of base educational services per child (CBSₘ) is taken into account when calculating T_{pc} for a particular child. In a situation where the employee of the child being provided services has a lower income, the business entity may decide to charge the employee less than the total monthly cost of base educational services per child (CBSₘ), in which case the business entity may decide to use a value of a that is less than 1, such as 0.5 or 0.6. In a situation where the employee of the child being provided services has a higher income, the business entity may decide to charge the employee close to or equal to the total monthly cost of base educational services per child (CBSₘ), in which case the business entity may decide to use a value of a that is closer to 1, such as 0.9 or 1.0.

The coefficient b may also be adjusted to vary the degree to which the fair market value for monthly rent for the commercial space is being deducted from the amount being charged to the employer or employee. Put another way, the coefficient b may be adjusted to vary the degree to which the fair market value for monthly rent is taken into account when calculating T_{pc} for a particular child. In a situation where the employee of the child being provided services has a lower income, the business entity may decide to allow the employee the full (or close to full) benefit of having the company pay for the rent/mortgage/lease for the space, and the business entity may decide to use a value of b that is closer to 1, such as 0.9 or 1.0. In a situation where the employee of the child being provided services has a higher income, the business entity may decide to allow the employee less than the full benefit of having the company pay for the rent/mortgage/lease for the space, and the business entity may decide to use a value of b that is less than 1, such as 0.2 or 0.3.

P, the monthly profit amount per child, may be adjusted over time to account for changes in the economy, changes in the consumer price index, changes in inflation, changes in the cost of services, and changes in the amount consumers are willing to pay for educational and non-educational services.

Sixth formula 212 shows how the business entity charges the company a monthly tuition charge for all children for the educational services it provides, wherein T is a total monthly tuition charge for all children for the educational services:

T=aC_{BE}−bRₘ+PTotal_{c}

wherein T is a total monthly tuition charge for the educational services for all children, C_{BE} represents total monthly cost to the business entity of providing educational and non-educational services for all children of employees of the company, Rₘ is fair market value for monthly rent/lease/mortgage for the commercial space, P is a monthly profit amount per child, Total_{c} is a total number of children being provided educational services, a is a coefficient real number with a range of 0≤a≤1 and b is a coefficient real number with a range of 0≤b≤1.

The coefficient a may be adjusted to vary the degree to which the total monthly cost to the business entity of providing educational and non-educational services for all children of employees of the company (C_{BE}) is being charged to the employer. Put another way, the coefficient a may be adjusted to vary the degree to which C_{BE} is taken into account when calculating T. In a situation where the business entity may decide to charge the employer less than C_{BE}, the business entity may decide to use a value of a that is less than 1, such as 0.5 or .6. In a situation where the business entity may decide to charge the employer close to or equal to C_{BE}, the business entity may decide to use a value of a that is closer to 1, such as 0.9 or 1.0.

The coefficient b may also be adjusted to vary the degree to which the fair market value for monthly rent for the commercial space is being deducted from the amount being charged to the employer. Put another way, the coefficient b may be adjusted to vary the degree to which the fair market value for monthly rent is taken into account when calculating T. In a situation where the business entity may decide to allow the employer the full (or close to full) benefit of having the company pay for the rent/mortgage/lease for the space, the business entity may decide to use a value of b that is closer to 1, such as 0.9 or 1.0. In a situation where the business entity may decide to allow the employer less than the full benefit of having the company pay for the rent/mortgage/lease for the space, the business entity may decide to use a value of b that is less than 1, such as 0.2 or 0.3.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An education management method, comprising:
creating a business entity for providing educational services to children of employees of a company;
occupying, by the business entity, a commercial space that is owned or leased by the company;
providing, by the business entity, educational services to the children of the employees within the commercial space; and
charging, by the business entity, the company for said educational services, wherein said charges are reduced proportional to savings realized by the business entity due to use of the commercial space that is owned or leased by the company.

2. The method of claim 1, wherein the commercial space is in the same commercial space used by the company to house said employees.

3. The method of claim 1, wherein the commercial space is substantially proximate to the commercial space used by the company to house said employees.

4. The method of claim 1, wherein the step of charging, by the business entity, the company for said educational services further comprises:
charging, by the business entity, the company a monthly tuition charge per child for the educational services based on the following formula:
T_{pc}=aCBSₘ−bRₘ/Total_{c}+P
wherein T_{pc} is a total monthly tuition charge per child for the educational services, CBSₘ is a total monthly cost of base educational services, R., is fair market value for monthly rent for the commercial space, P is a monthly profit amount per child, Total is a total number of children being provided educational services, a is a coefficient real number with a range of 0≤a≤1 and b is a coefficient real number with a range of 0≤b≤1.

5. The method of claim 1, wherein the step of charging, by the business entity, the company for said educational services further comprises:
charging, by the business entity, the company a monthly tuition charge for the educational services based on the following formula:
T=aC_{BE}−bRₘ+PTotal_{c}
wherein T is a total monthly tuition charge for the educational services, C_{BE} is total monthly cost to the business entity of providing said educational services for all children of the employees of the company, Rₘ is fair market value for monthly rent for the commercial space, P is a monthly profit amount per child, Total_{c} is a total number of children being provided educational services, a is a coefficient real number with a range of 0≤a≤1 and b is a coefficient real number with a range of 0≤b≤1.

6. The method of claim 1, further comprising:
receiving, by the company, a tax credit proportional to the total number of children that are provided educational services by the business entity and proportional to mortgage or rent the company pays for the commercial space.

7. The method of claim 1, further comprising:
deducting, by the company, less than or equal to 35% of unrecovered costs associated with said commercial space from a corporate tax associated with the company.

8. The method of claim 1, wherein the educational services comprise daycare.

9. The method of claim 1, wherein the educational services comprise preschool through eighth grade instruction.

10. An education management method, comprising:
creating a business entity for providing preschool through eighth grade instruction to children of employees of a company;
occupying, by the business entity, a commercial space that is owned or leased by the company;
providing, by the business entity, preschool through eighth grade instruction to the children of the employees within the commercial space; and
charging, by the business entity, the company for said preschool through eighth grade instruction, wherein said charges are reduced proportional to savings realized by the business entity due to use of the commercial space that is owned or leased by the company.

11. The method of claim 10, wherein the commercial space is in the same commercial space used by the company to house said employees.

12. The method of claim 10, wherein the commercial space is substantially proximate to the commercial space used by the company to house said employees.

13. The method of claim 10, wherein the step of charging, by the business entity, the company for said preschool through eighth grade instruction further comprises:
charging, by the business entity, the company a monthly tuition charge per child for the preschool through eighth grade instruction based on the following formula:
T_{pc}=aCBSₘ−bRₘ/Total_{c}+P
wherein T_{pc} is a total monthly tuition charge per child for the preschool through eighth grade instruction, CBSₘ is a total monthly cost of base preschool through eighth grade instruction, Rₘ is fair market value for monthly rent for the commercial space, P is a monthly profit amount per child, Total_{c} is a total number of children being provided preschool through eighth grade instruction, a is a coefficient real number with a range of 0≤a≤1 and b is a coefficient real number with a range of 0≤b≤1.

14. The method of claim 10, wherein the step of charging, by the business entity, the company for said preschool through eighth grade instruction further comprises:
charging, by the business entity, the company a monthly tuition charge for the preschool through eighth grade instruction based on the following formula:
T=aC_{BE}−bRₘ+PTotal_{c}
wherein T is a total monthly tuition charge for the preschool through eighth grade instruction, C_{BE} is total monthly cost to the business entity of providing said preschool through eighth grade instruction for all children of the employees of the company, Rₘ is fair market value for monthly rent for the commercial space, P is a monthly profit amount per child, Total_{c} is a total number of children being provided preschool through eighth grade instruction, a is a coefficient real number with a range of 0≤a≤1 and b is a coefficient real number with a range of 0≤b≤1.

15. The method of claim 10, further comprising:
receiving, by the company, a tax credit proportional to the total number of children that are provided preschool through eighth grade instruction by the business entity and proportional to mortgage or rent the company pays for the commercial space.

16. The method of claim 10, further comprising:
deducting, by the company, less than or equal to 35% of unrecovered costs associated with said commercial space from a corporate tax associated with the company.

17. An education management method, comprising:
creating a business entity for providing preschool through eighth grade instruction to children of employees of a company;
occupying, by the business entity, a commercial space that is owned or leased by the company;
providing, by the business entity, preschool through eighth grade instruction to the children of the employees within the commercial space; and
charging, by the business entity, parents of the children for said preschool through eighth grade instruction, wherein said charges are reduced proportional to savings realized by the business entity due to use of the commercial space that is owned or leased by the company.

18. The method of claim 17, wherein the step of charging, by the business entity, the parents of the children for said preschool through eighth grade instruction further comprises:
charging, by the business entity, the parents of the children a monthly tuition charge per child for the preschool through eighth grade instruction based on the following formula:
T_{pc}=aCBSₘ−bRₘ/Total_{c}+P
wherein T_{pc} is a total monthly tuition charge per child for the preschool through eighth grade instruction, CBSₘ is a total monthly cost of base preschool through eighth grade instruction, Rₘ is fair market value for monthly rent for the commercial space, P is a monthly profit amount per child, Total_{c} is a total number of children being provided preschool through eighth grade instruction, a is a coefficient real number with a range of 0≤a≤1 and b is a coefficient real number with a range of 0≤b≤1.

19. The method of claim 18, further comprising:
receiving, by the company, a tax credit proportional to the total number of children that are provided preschool through eighth grade instruction by the business entity and proportional to mortgage or rent the company pays for the commercial space.
